(19) United States
(12) Patent Application Publication
(10) Pub. No.: US 2012/0212132 A1
(43) Pub. Date: Aug. 23, 2012

(54) LIGHT DEVICE CONTROL APPARATUS FOR VEHICLE

(75) Inventor: Koji Sakaguchi, Obu-city (JP)

(73) Assignee: DENSO CORPORATION, Kariya-city (JP)

(21) Appl. No.: 13/364,577

(22) Filed: Feb. 2, 2012

(30) Foreign Application Priority Data
Feb. 18, 2011 (JP) 2011-32869

(51) Int. Cl. B60Q 1/02

(52) U.S. Cl. 315/77

(57) ABSTRACT

A vehicle light device control apparatus includes a sensor unit and a control unit. The sensor unit detects an upper light intensity of light coming from an upper side of a vehicle and a front light intensity of light coming from a front side of the vehicle. The control unit determines whether the upper light intensity is equal to or less than a predetermined turn-ON threshold. The control unit turns ON a light device of the vehicle when the upper light intensity is equal to or less than the turn-ON threshold. The control unit calculates a light intensity ratio between the front light intensity and the upper light intensity and corrects the turn-ON threshold based on the light intensity ratio.

### CROSS REFERENCE TO RELATED APPLICATION

This application is based on and claims priority to Japanese Patent Application No. 2011-32869 filed on Feb. 18, 2011, the contents of which are incorporated by reference.

### FIELD

The present invention relates to an apparatus for controlling a light device of a vehicle that illuminates an area outside the vehicle.

### BACKGROUND

US 2010/0079072 corresponding to JP-A-2010-83409 discloses a control apparatus that detects upper and front light intensities (i.e., light illumination) of light coming from the upper and front sides of a vehicle and turns ON and OFF a light device of the vehicle according to the detected light intensities. In the conventional control apparatus, when it becomes dark in the evening or when the vehicle enters a tunnel, the light device is turned ON.

Assuming that a light sensor for detecting the upper and front light intensities is mounted on a windshield (i.e., front window) of the vehicle, the light intensities detected by the light sensor may vary depending on the heading direction of the vehicle. For example, when the vehicle heads westward in the evening, the light sensor is subjected to direct sunlight. In contrast, when the vehicle heads eastward in the evening, the light sensor is in the shade. Therefore, in the evening, the light device is frequently turned ON and OFF each time the heading direction of the vehicle changes. The frequent ON and OFF of the light device can make users uncomfortable.

### SUMMARY

In view of the above, it is an object of the present invention to provide an apparatus for suitably controlling a light device of a vehicle.

According to an aspect of the present invention, a vehicle light device control apparatus includes an upper light intensity detection circuit, a front light intensity detection circuit, a determination circuit, a control circuit, a calculation circuit, and a correction circuit. The upper light intensity detection circuit detects an upper light intensity of light coming from an upper side of a vehicle. The front light intensity detection circuit detects a front light intensity of light coming from a front side of the vehicle. The determination circuit determines whether the upper light intensity is equal to or less than a predetermined turn-ON threshold. The control circuit turns ON a light device of the vehicle when the upper light intensity is equal to or less than the turn-ON threshold. The calculation circuit calculates a light intensity ratio between the front light intensity and the upper light intensity. The correction circuit corrects the turn-ON threshold based on the light intensity ratio.

### BRIEF DESCRIPTION OF THE DRAWINGS

The above and other objects, features, and effects will become more apparent from the following description and drawings in which like reference numerals depict like elements. In the drawings:

FIG. 1 is a block diagram of a vehicle light device control apparatus according to an embodiment of the present invention;

FIG. 2 is a diagram illustrating light receiving areas of upper and front light intensity sensors of the vehicle light device control apparatus;

FIG. 3 is a diagram illustrating a vehicle equipped with the vehicle light device control apparatus;

FIG. 4 is a diagram illustrating a relationship between a position of the sun and upper and front light intensities detected by the upper and front light intensity sensors; and

FIG. 5 is a flow diagram of the vehicle light device control apparatus.

### DETAILED DESCRIPTION OF THE PREFERRED EMBODIMENT

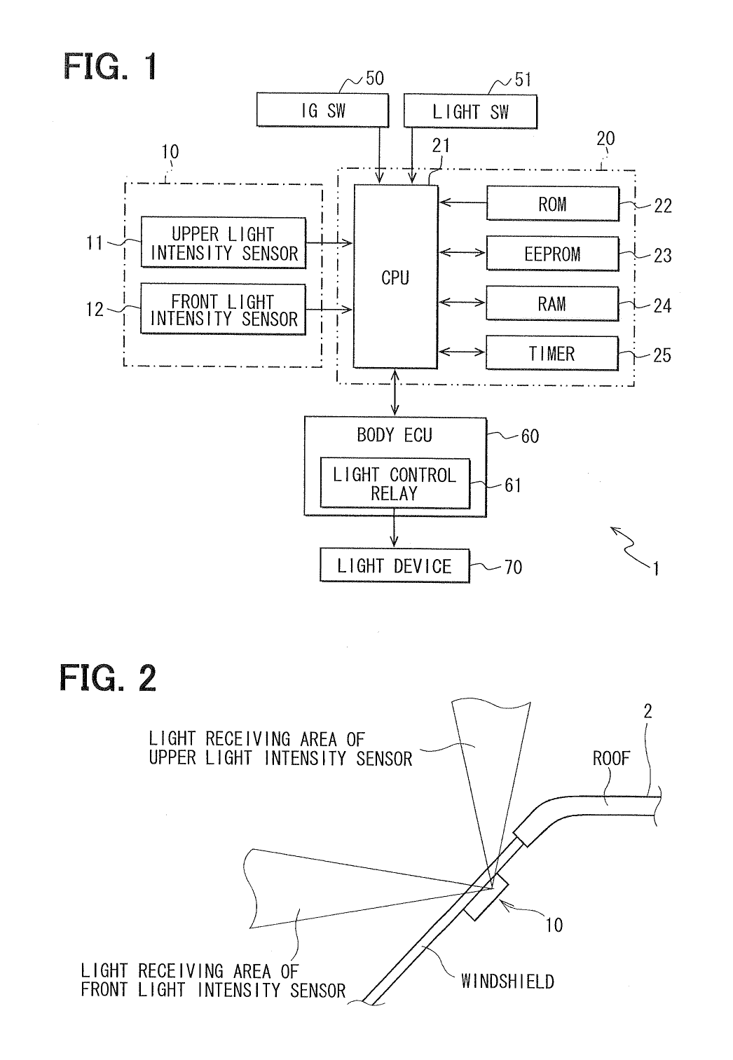

A vehicle light device control apparatus 1 according to an embodiment of the present invention is described below with reference to FIGS. 1-5. As shown in FIG. 1, the control apparatus 1 includes a sensor unit 10, a light electronic control unit (ECU) 20, a body ECU 60, and a light device 70.

The sensor unit 10 detects a light intensity (i.e., illumination) of light outside a vehicle 2 equipped with the control apparatus 1. The sensor unit 10 includes an upper light intensity sensor 11 and a front light intensity sensor 12. Each of the upper light intensity sensor 11 and the front light intensity sensor 12 can be a conventional illuminometer such as a photodiode.

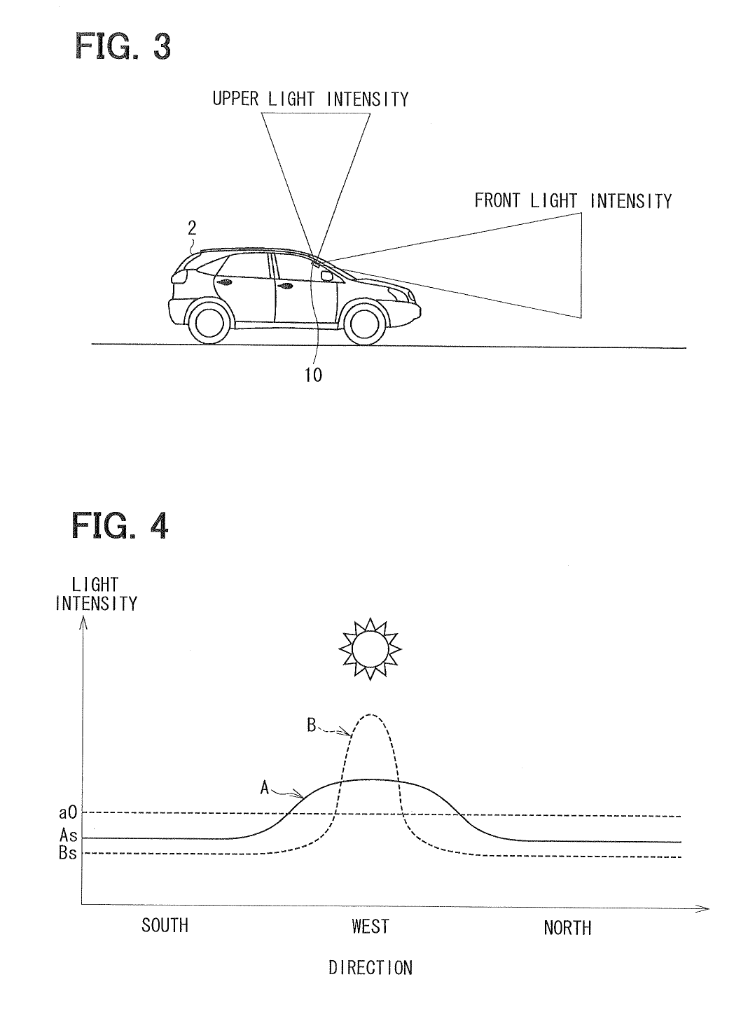

As shown in FIGS. 2 and 3, the sensor unit 10 is mounted on an inner surface of a windshield (i.e., front window) of the vehicle 2. The upper light intensity sensor 11 detects an upper light intensity of light coming from an upper side of the vehicle 2 within a predetermined incident angle range and outputs an upper light intensity detection signal, indicative of the detected upper light intensity, to the light ECU 20. The front light intensity sensor 12 detects a front light intensity of light coming from a front side of the vehicle 2 within a predetermined incident angle range and outputs a front light intensity detection signal, indicative of the detected front light intensity, to the light ECU 20.

Referring back to FIG. 1, the light ECU 20 is mainly constructed with a conventional microcomputer and includes a central processing unit (CPU) 21, a read-only memory (ROM) 22, an electrically erasable programmable read-only memory (EEPROM) 23 as a nonvolatile memory, a random access memory (RAM) 24, a timer 25, an input/output (I/O) section (not shown), and a bus for connecting these components.

The CPU 21 is connected to an ignition switch 50, a light switch 51, and the body ECU 60. The ROM 22 stores control programs executed by the CPU 21. The EEPROM 23 stores an initial turn-ON threshold a0. The EEPROM 23 further stores a light delay time Td. The RAM 24 is used as a working memory space for allowing the CPU 21 to execute the programs. The timer 25 counts time.

The light switch 51 is operable by a user to activate and deactivate the auto light control system. For example, the light switch 51 can be installed near a steering wheel of the vehicle 2.

The body ECU 60 has a light control relay 61 as a mechanism for tuning ON and OFF the light device 70.

The light device 70 is a device for illuminating the area outside the vehicle 2. The light device 70 can include a headlamp, a front position lamp, and a rear position lamp of the vehicle 2. The light device 70 can further include a fog lamp and/or the like.

FIG. 4 illustrates a relationship between a heading direction of the vehicle 2 and the upper and front light intensities in the evening when the sun is low in the west. In FIG. 4, a solid line A represents the upper light intensity, and a broken line B represents the front light intensity. As can be seen from FIG. 4, when the heading direction of the vehicle 2 is not west in the evening, i.e., when the sensor unit 10 is not subjected to direct sunlight, the upper light intensity A is almost constant at As, and the front light intensity B is almost constant at Bs. Therefore, when the sensor unit 10 is not subjected to direct sunlight, an intensity light ratio R of the front light intensity B to the upper light intensity A is almost constant at Bs/As. According to the embodiment, the intensity light ratio R when the sensor unit 10 is not subjected to direct sunlight is defined as a reference value S. That is, S=Bs/As.

The reference value S is precalculated and prestored in the ROM 22 or the EEPROM 23. That is, the constant upper light intensity As and the constant front light intensity Bs are premeasured. For example, the measurement of the constant upper light intensity As, the measurement of the constant front light intensity Bs, and the calculation of the reference value S can be performed before the sensor unit 10 is mounted on the vehicle 2. It is preferable that the constant upper light intensity As and the constant front light intensity Bs be measured when the sensor unit 10 faces the east direction in the evening or when the sensor unit 10 faces the west direction in the early morning.

As can be seen form FIG. 4, in the evening, the upper light intensity A and the front light intensity B are larger when the heading direction of the vehicle 2 is west than when the heading direction of the vehicle 2 is not west. Further, although the upper light intensity A is larger than the front light intensity B when the heading direction of the vehicle 2 is not west, the upper light intensity A is smaller than the front light intensity B when the heading direction of the vehicle 2 is west. That is, the intensity light ratio R is larger when the heading direction of the vehicle 2 is west than when the heading direction of the vehicle 2 is not west.

In an example of FIG. 4, the upper light intensity A is smaller than the initial turn-ON threshold a0 when the heading direction of the vehicle 2 is not west and larger than the initial turn-ON threshold a0 when the heading direction of the vehicle 2 is west. Therefore, the light device 70 is frequently turned ON and OFF each time the heading direction of the vehicle 2 changes. Further, the light device 70 may be turned ON with delay when the heading direction of the vehicle 2 is west compared to when the heading direction of the vehicle 2 is not west.

To prevent the above disadvantages, according to the embodiment, the prestored initial turn-ON threshold a0 is corrected based on the light intensity ratio R of the front light intensity B to the upper light intensity A so that the light device 70 can be suitably turned ON.

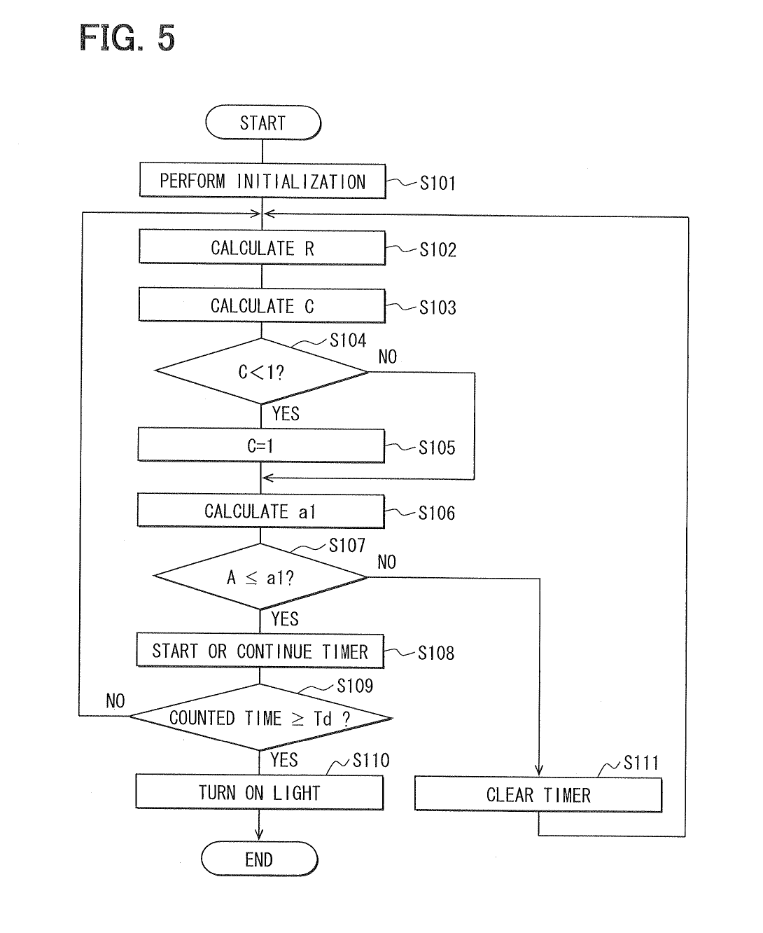

A light control process according to the embodiment is described below with reference to FIG. 5. The CPU 21 of the light ECU 20 executes the light control process at a predetermined time interval (e.g., 100 milliseconds), when the auto light control system is activated by the light switch 51.

The control process starts at S101, where the CPU 21 performs initialization. Specifically, at S101, the CPU 21 resets the RAM 24 and the timer 25. Then, the control process proceeds to S102, where the CPU 21 obtains the upper light intensity A and the front light intensity B and calculates the light intensity ratio R of the front light intensity B to the upper light intensity A. The light intensity ratio R becomes larger, when the front light intensity B increases relative to the upper light intensity A, for example, when the vehicle 2 heads westward in the evening.

Then, the control process proceeds to S103, where the CPU 21 calculates a correction coefficient C used for correcting the initial turn-ON threshold a0. The correction C is calculated by dividing the light intensity ratio R by the reference value S. That is, C=R/S.

Then, the control process proceeds to S104, where the CPU 21 determines whether the correction coefficient C is less than 1. If the correction coefficient C is less than 1 corresponding to YES at S104, the control process proceeds to S105, where the CPU 21 sets the correction coefficient C to 1. In contrast, if the correction coefficient C is equal to or larger than 1 corresponding to NO at S104, the control process jumps to S106 by skipping S105.

At S106, the CPU 21 calculates a new turn-ON threshold at by correcting the initial turn-ON threshold a0 based on the correction coefficient C. Specifically, the new turn-ON threshold a1 is calculated by multiplying the initial turn-ON threshold a0 by the correction coefficient C. That is, a1=a0xC. As mentioned above, if the correction coefficient C is less than 1 at S104, the correction coefficient C is set to 1 at S105. Therefore, the new turn-ON threshold a1 always becomes equal to or larger than the initial turn-ON threshold a0.

Then, the control process proceeds to S107, where the CPU 21 determines whether the upper light intensity A is equal to or less than the new turn-ON threshold a1. If the upper light intensity A is larger than the new turn-ON threshold at corresponding to NO at S107, the control process proceeds to S111, where the CPU 21 clears the timer 25. After S111, the control process returns to S102. In contrast, if the upper light intensity A is equal to or less than the new turn-ON threshold at corresponding to YES at S107, the control process proceeds to S108, where the CPU 21 causes the timer 25 to start or continue to count time.

Then, the control process proceeds to S109, where the CPU 21 determines whether the time counted by the timer 25 is equal to or larger than the light delay time Td. If the counted time is less than the light delay time Td corresponding to NO at S109, the control process returns to S102. In contrast, if the counted time is equal to or larger than the light delay time Td corresponding to YES at S109, the control process proceeds to S110, where the CPU 21 turns ON the light device 70.

For example, after being turned ON, the light device 70 can be turned OFF when a predetermined time elapses from when the upper light intensity A increases to or above a predetermined turn-OFF threshold.

According to the embodiment, when the light receiving area of the front light intensity sensor 12 faces a light source such as the sun (e.g., when the vehicle 2 heads westward in the evening), the front light intensity B increases relative to the upper light intensity A. In this case, the light intensity ratio R becomes larger than the reference value S so that the correction coefficient C can become larger than 1. Therefore, the new turn-ON threshold a1, which is calculated by multiplying the initial turn-ON threshold a0 by the correction coefficient C, becomes larger than the initial turn-ON threshold a0. As shown in FIG. 4, when the vehicle 2 heads westward in the evening, the sensor unit 10 is subjected to the direct sunlight. Therefore, in the evening, the upper light intensity A is larger when the vehicle 2 heads westward than when the vehicle 2 does not head westward. However, according to the embodiment, the initial turn-ON threshold a0 is corrected to the new turn-ON threshold a1 based on the light intensity ratio R so that the new turn-ON threshold a1 can be larger than the initial turn-ON threshold a0. Thus, in the evening, the light device 70 is turned ON under condition that the upper light intensity A is higher, when the vehicle 2 heads westward compared to when the vehicle 2 does not head westward. Thus, the light device 70 can be turned ON under a predetermined fixed condition regardless of the heading direction of the vehicle 2. Therefore, the frequent ON and OFF of the light device 70 due to the change of the heading direction of the vehicle 2 can be avoided. Further, the light device 70 can be turned ON without delay when the heading direction of the vehicle 2 is west.

Further, according to the embodiment, the correction coefficient C used for correcting the initial turn-ON threshold a0 is less than 1, the correction coefficient C1 is set to 1 (S104:YES, S105) to prevent the new turn-ON threshold a1 from being less than the initial turn-ON threshold a0. Thus, even when the front light intensity B decreases, for example, due to an object in front of the vehicle 2, the new turn-ON threshold a1 can be equal to or larger than the initial turn-ON threshold a0. Therefore, the light device 70 can be turned ON without delay even when the front light intensity B decreases, for example, due to an object in front of the vehicle 2.

Further, according to the embodiment, the initial turn-ON threshold a0 is corrected to the new turn-ON threshold a1 at S106 each time it is determined at S107 whether the light device 70 is turned ON based on the upper light intensity A and the new turn-ON threshold a1. Thus, the initial turn-ON threshold a0 can be suitably corrected to the new turn-ON threshold a1 according to conditions (e.g., heading direction and the time of the day) of the vehicle 2 so that the light device 70 can be suitably turned ON based on the new turn-ON threshold a1.

FIG. 4 shows that in the evening, the upper light intensity A and the front light intensity B are larger when the heading direction of the vehicle 2 is west than when the heading direction of the vehicle 2 is not west. Likewise, in the early morning, the upper light intensity A and the front light intensity B are larger when the heading direction of the vehicle 2 is east than when the heading direction of the vehicle 2 is not east.

The embodiment can be summarized as follows. The vehicle light device control apparatus 1 controls ON and OFF of the light device 70 that illuminates the area outside the vehicle 2. The control apparatus 1 includes the upper light intensity sensor 11, the front light intensity sensor 12, and the light ECU 20. The upper light intensity sensor 11 detects the upper light intensity of light coming from the upper side of the vehicle 2. The front light intensity sensor 12 detects the front light intensity of light coming from the front side of the vehicle 2. The light ECU 20 determines whether the upper light intensity A is equal to or less than the new turn-ON threshold a1 (S107 in FIG. 5). If the light ECU 20 determines that the upper light intensity A is equal to or less than the new turn-ON threshold a1 (YES at S107), the light ECU 20 turns ON the light device 70. Further, the light ECU 20 calculates the light intensity ratio R of the front light intensity B to the upper light intensity A and corrects the initial turn-ON threshold a0 based on the light intensity ratio R.

The correction coefficient C is calculated based on the light intensity ratio R of the front light intensity B to the upper light intensity A, and the initial turn-ON threshold a0 is corrected to the new turn-ON threshold a1 by multiplying the initial turn-ON threshold a0 by the correction coefficient C. In such an approach, the light device 70 can be turned ON under a predetermined condition regardless of the heading direction of the vehicle 2.

When the light intensity ratio R is larger than the reference value S, the initial turn-ON threshold a0 is corrected so that the new turn-ON threshold a1 can be larger than the initial turn-ON threshold a0 (S106). Specifically, when the correction coefficient C, which is calculated by dividing the light intensity ratio R by the reference S, is larger than 1 (NO at S104), the new turn-ON threshold at is calculated by multiplying the initial turn-ON threshold a0 by the correction coefficient C of larger than 1. Thus, the new turn-ON threshold a1 can become larger than the initial turn-ON threshold a0. Therefore, the light device 70 can be turned ON without delay, for example, even when the sensor unit 10 is subjected to direct sunlight in the evening.

In contrast, when the light intensity ratio R is less than the reference value S, the initial turn-ON threshold a0 is not corrected so that the new turn-ON threshold a1 can be equal to the initial turn-ON threshold a0 (S105, S106). Specifically, when the correction coefficient C, which is calculated by dividing the light intensity ratio R by the reference S, is less than 1 (YES at S104), the correction coefficient C is set to 1 so that the new turn-ON threshold a1, which is calculated by multiplying the initial turn-ON threshold a0 by the correction coefficient C of 1, can be equal to the initial turn-ON threshold a0. That is, when the front light intensity B is relatively large, the initial turn-ON threshold a0 is corrected to the new turn-ON threshold a1 that is larger than the initial turn-ON threshold a0. However, even when the front light intensity B is relatively small, the initial turn-ON threshold a0 is not corrected to the new turn-ON threshold a1 that is less than the initial turn-ON threshold a0. Thus, even when the front light intensity B is small, for example, due to an object in front of the vehicle 2, the light device 70 can be turned ON based on the new turn-ON threshold a1 without delay.

The reference value S is defined as a ratio of the upper light intensity B to the front light intensity A when the sensor unit 10 is not subjected to direct light. As shown in FIG. 4, when the sensor unit 10 is not subjected to direct light (e.g., sunlight), the upper light intensity A is almost constant at As, and the front light intensity B is almost constant at Bs. Therefore, when the sensor unit 10 is not subjected to direct light, the intensity light ratio R of the front light intensity B to the upper light intensity A is almost constant at Bs/As. Therefore, the increase in the front light intensity B due to direct light can be taken into consideration by using the reference value S so that the initial turn-ON threshold a0 can be suitably corrected to the new turn-ON threshold a1.

The initial turn-ON threshold a0 is corrected to the new turn-ON threshold a1 each time it is determined whether the upper light intensity A is equal to or larger than the new turn-ON threshold a1. Thus, the initial turn-ON threshold a0 can be suitably corrected to the new turn-ON threshold a1 according to conditions (e.g., heading direction and the time of the day) of the vehicle 2 so that the light device 70 can be suitably turned ON based on the new turn-ON threshold a1.

The upper light intensity sensor 11 serves as an upper light intensity detection circuit. The front light intensity sensor 12 serves as a front light intensity detection circuit. The light ECU 20 serves as a determination circuit for determining whether the upper light intensity is equal to or less than a predetermined turn-ON threshold, a control circuit for turning ON the light device when the upper light intensity is equal to or less than the turn-ON threshold, a calculation circuit for calculating a light intensity ratio between the front light intensity and the upper light intensity, and a correction circuit for correcting the turn-ON threshold based on the light intensity ratio.

(Modification)

The above embodiment described above can be modified in various ways, for example, as follows.

In the embodiment, the sensor unit 10 is mounted on the inner surface of the windshield of the vehicle 2. Alternatively, the sensor unit 10 can be mounted on a portion other than the inner surface of the windshield of the vehicle 2. For example, the sensor unit 10 can be mounted on the dashboard of the vehicle 2. The upper light intensity sensor 11 and the front light intensity sensor 12 can be mounted on different portions of the vehicle 2.

In the embodiment, the correction coefficient C is calculated based on the light intensity ratio R and the reference value S, and the initial turn-ON threshold a0 is corrected to the new turn-ON threshold a1 based on the correction coefficient C. Alternatively, a map defining a relationship between the light intensity ratio R and the correction coefficient C can be prestored in the ROM 22 or the EEPROM 23, and the initial turn-ON threshold a0 can be corrected to the new turn-ON threshold a1 based on the map. In this case, the correction coefficient C can be obtained by referring to the map at S103 in FIG. 5, and S104 and S105 can be omitted. Alternatively, a map defining a relationship between the light intensity ratio R and the new turn-ON threshold a1 can be prestored in the ROM 22 or the EEPROM 23. In this case, S103, S104, and S105 in FIG. 5 can be omitted, and the new turn-ON threshold a1 can be obtained by referring to the map at S106.

In the embodiment, the light device 70 is turned ON when the upper light intensity A is equal to or less than the new turn-ON threshold a1. Alternatively, the light device 70 can be turned ON when both the upper light intensity A and the front light intensity B are equal to or less than a predetermined turn-ON threshold at the time of day other than in the early morning and the evening.

In the embodiment, the upper light intensity sensor 11 detects the upper light intensity and outputs the upper light intensity detection signal, indicative of the detected upper light intensity, to the light ECU 20. In this case, the light ECU 20 calculates the upper light intensity from the upper light intensity detection signal. Alternatively, the light ECU 20 can interpret the upper light intensity detection signal as the upper light intensity. Likewise, the light ECU 20 can interpret the front light intensity detection signal as the front light intensity.

In the embodiment, the light intensity ratio is the ratio of the front light intensity B to the upper light intensity A. Alternatively, the light intensity ratio can be a ratio of the upper light intensity A to the front light intensity B.

Such changes and modifications are to be understood as being within the scope of the present invention as defined by the appended claims.

What is claimed is:

1. An apparatus for controlling a vehicle light device that illuminates an area outside a vehicle, the apparatus comprising:
an upper light intensity detection circuit configured to detect an upper light intensity of light coming from an upper side of the vehicle;
a front light intensity detection circuit configured to detect a front light intensity of light coming from a front side of the vehicle;
a determination circuit configured to determine whether the upper light intensity is equal to or less than a predetermined turn-ON threshold;
a control circuit configured to turn ON the light device when the upper light intensity is equal to or less than the turn-ON threshold;
a calculation circuit configured to calculate a light intensity ratio between the front light intensity and the upper light intensity; and
a correction circuit configured to correct the turn-ON threshold based on the light intensity ratio.

2. The apparatus according to claim 1, wherein
the correction circuit determines whether the light intensity ratio of the front light intensity to the upper light intensity is larger than a reference ratio of a reference front light intensity to a reference upper light intensity, and
when the light intensity ratio is larger than the reference ratio, the correction circuit corrects the turn-ON threshold to increase the turn-ON threshold.

3. The apparatus according to claim 2, wherein
when the light intensity ratio is less than the reference ratio, the correction circuit corrects the turn-ON threshold to maintain the turn-ON threshold unchanged.

4. The apparatus according to claim 2, wherein
the reference upper light intensity is detected by the upper light intensity detection circuit when the upper light intensity detection circuit is not subjected to direct sunlight, and
the reference front light intensity is detected by the front light intensity detection circuit when the front light intensity detection circuit is not subjected to the direct sunlight.

5. The apparatus according to claim 1, wherein
the correction circuit corrects the turn-ON threshold each time the determination circuit determines whether the upper light intensity is equal to or less than the turn-ON threshold.
